(19) United States
(12) Patent Application Publication
(10) Pub. No.: US 2020/0206774 A1
(43) Pub. Date: Jul. 2, 2020

(54) Caulking Gun

(71) Applicants: Luis A. Acosta, Wichita, KS (US); Yadira A. Acosta, Wichita, KS (US)

(72) Inventor: Luis A. Acosta, Wichita, KS (US)

(73) Assignees: Luis A. Acosta, Wichita, KS (US); Yadira A. Acosta, Wichita, KS (US)

(21) Appl. No.: 16/817,015

(22) Filed: Mar. 12, 2020

(51) Int. Cl. B05C 17/01

(52) U.S. Cl. CPC B05C 17/0123

(57) ABSTRACT

A caulking gun incorporating a caulk tube receptacle having a dispensing end a handle end; a plunger rod having a dispensing end and having a handle end, the dispensing end of the plunger rod extending toward the caulk tube receptacle's dispensing end and the handle end of the plunger rod extending away from the caulk tube receptacle's handle end; a trigger actuator operatively supporting the plunger rod at the caulk tube receptacle's handle end; a hammerhead; and a mounting sleeve fixedly attaching the hammerhead to the handle end of the plunger rod, the caulking gun being alternatingly useable as a caulk applying tool and as a hammer for resetting protruding nail heads.

### FIELD OF THE INVENTION

This invention relates to caulking guns of the type including a caulk tube receptacle or frame, such guns further having a handle and trigger actuator assembly for holding and directing the gun and for trigger actuated driving a caulk dispensing plunger rod. More particularly, this invention relates to special adaptations of such caulking guns which are directed to making them more functional during use in painting preparation processes.

### BACKGROUND OF THE INVENTION

Painting preparation work performed upon a building having exterior wall boards commonly includes a step of applying water sealing caulking at the edges of the wall boards and at exposed nail heads. Nails commonly used to hold wall boards upon underlying wall frame members may create water incursion pathways which may lead to water rot. A common remedial practice applies the caulk at the sites of the nail heads during painting preparation, such practice sealing the nail heads and assuring that water incursions and water rot does not occur at the nail heads.

Workers who perform painting preparation work often find nail heads which are raised a short distance above the wall surface. Expansions and contractions of the wall board occurring during successive winter and summer months are known to undesirably draw nail heads away from their originally set and flush configurations. Application of sealing caulk to such nails is particularly needed. However, prior to any application of caulk, a raised nail must be driven back to its original seated and flush configuration. In situations where the worker performing the caulking preparation is situated at the top of a ladder, the worker often utilizes one of his or her hands to secure and balance himself upon the ladder. The worker's other hand is typically occupied with wielding and manipulating a caulking gun. Where a raised nail head is encountered, such occupations of the worker's hands makes it inconvenient and difficult for the worker to reset the nail. The worker's hand which is occupied with holding and balancing upon the ladder is typically of no assistance in resetting the nail. The worker's other hand which holds the caulking gun is similarly disabled from assisting in resetting the nail. Performing additional steps of releasing and temporarily storing the caulking gun, accessing and retrieving a separate hammer tool, utilizing the hammer to set the nail, returning the hammer to its storage place, and retrieving the caulking gun for continued caulking are cumbersome, awkward, and time consuming.

The instant inventive caulking gun solves or ameliorates problems, defects, deficiencies, and challenges discussed above by providing a specially adapted caulking gun which is capable of alternatively functioning as a nail setting hammer.

### BRIEF SUMMARY OF THE INVENTION

A first structural component of the instant inventive caulking gun comprises a caulk tube receptacle or frame having a caulk dispensing end and having a handle end. In the preferred embodiment, the caulk tube receptacle is specially fitted and adapted for receiving a standard sized caulk tube.

A further structural component of the instant inventive caulking gun comprises a plunger rod having a dispensing end and having a handle end. In the preferred embodiment, the plunger rod has a piston driving disk or plate mounted to its dispensing end, and the plunger rod has a hook, often configured as an “L”, formed via a bend at its handle end. A handle and trigger actuator mechanism is preferably incorporated at the handle end of the receptacle, such mechanism supporting and longitudinally driving the plunger rod toward the dispensing end of the receptacle. In a preferred embodiment, the actuator mechanism comprises a pair of shaft binding slip plates wherein a longitudinal plate drives the plunger rod longitudinally and wherein an oppositely longitudinal slip plate resists any oppositely longitudinal motion of the lunger rod while the longitudinal slip plate is drawn oppositely longitudinally.

Where a caulk tube is received within the receptacle, actuation and manipulation of the trigger actuator drives the plunger rod longitudinally within the bore of a caulk tube, driving the caulk tube's piston toward the tube's caulk dispensing end, thereby dispensing caulk from the caulk tube's dispensing tip.

A further structural component of the instant inventive caulking gun comprises a hammerhead which is preferably composed of steel and has a mass sufficient to effectively set a protruding nail head.

Means for mounting the hammerhead component upon the handle end of the plunger rod are preferably provided. Suitably, such means may comprise a welded, wholly formed, helically threaded, pressure fitted, clamping, or adhesively bonded attachment of the hammerhead to a distal end of the plunger rod's hook. In a preferred embodiment, the mounting means comprise a pin and socket joint wherein the joint's pin half comprises a distal end of the plunger rod's hook. The socket half of such joint comprises the bore of a steel sleeve, and the hammerhead is preferably welded to a distal end of such sleeve.

Provision of such pin and socket joint means for mounting of the hammerhead allows the joint itself to perform an additional ergonomic function of increasing the radius of curvature of the plunger rod's pull handle.

In use of the instant invention, and assuming that pin and socket joint hammerhead mounting means are provided, an operator may initially grasp the inventive caulking gun in one hand and may grasp the sleeve component in his or her other hand. Thereafter, the operator may depress the caulking gun's plunger rod release latch, and may pull rearwardly upon the enlarged cylindrical outer surface of the sleeve. Such rearward pulling translates to the hook and oppositely longitudinally withdraws the plunger rod's piston driving disk from the interior of the caulk tube. Where the caulk tube is spent and is in need of removal from the receptacle and disposal, such plunger rod withdrawal is needed. The effective increase of radius of curvature of the hook provided by the sleeve component provides comfort and security in utilizing fingers to effect the needed pull upon the plunger rod.

In alternative hammering use of the instant inventive caulking gun, an operator may grasp the gun via its caulk tube receptacle (and via a caulk tube received within the receptacle). Thereafter, the operator may swing the handle end of the caulking gun toward a nail to be reset. Such swinging motion is preferably guided so that the hammerhead component may percussively strike the nail head, advantageously driving and resetting the nail head. Thereafter, the caulking gun may be further alternatively utilized in a conventional fashion to apply caulk at the site of the reset nail head.

Accordingly, objects of the instant invention include the provision of a caulking gun which incorporates structures as described above, and which arranges those structures in manners described above, for the achievement and performance of beneficial functions described above.

Other and further objects, benefits, and advantages of the instant invention will become known to those skilled in the art upon review of the Detailed Description which follows, and upon review of the appended drawings.

### BRIEF DESCRIPTION OF THE DRAWINGS

FIG. 1 is a side view of the instant inventive caulking gun, the view including a cut away exposing internal structures.

FIG. 2 redepicts the structure of FIG. 1, the view of FIG. 2 showing a hammerhead and mounting sleeve component in an exploded view.

FIG. 3 is a sectional view, as indicated in FIG. 1.

FIG. 4 presents an alternative configuration of the structure depicted in FIG. 1.

### DETAILED DESCRIPTION OF A PREFERRED EMBODIMENT

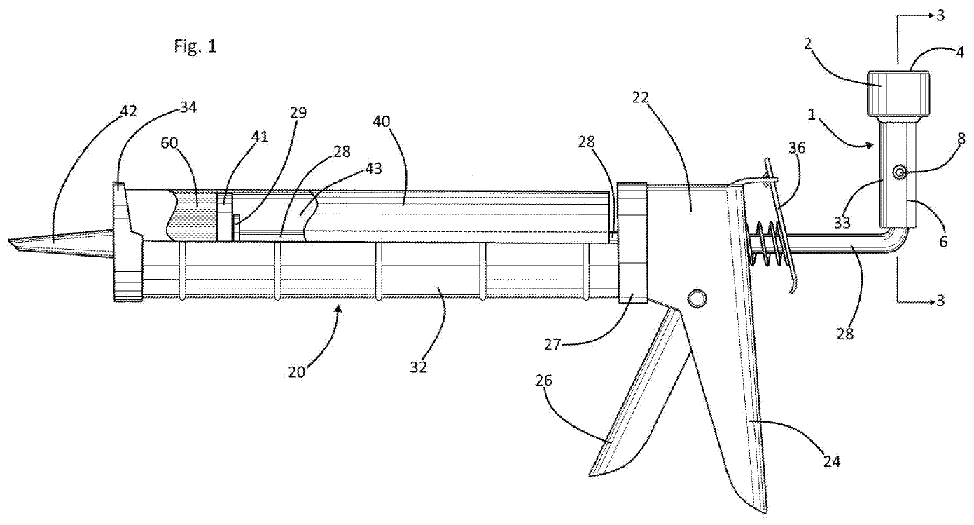

Referring now to the drawings and in particular to Drawing FIG. 1, a preferred embodiment of the instant inventive caulking gun is referred to generally by Reference Arrow 20. The caulking gun 20 includes a frame or receptacle member 32 which is closely fitted and adapted for receiving a conventional piston type caulk dispensing tube 40, such tube having a forward or longitudinal caulk dispensing nipple 42. A forward bracket 34 captures and retains the dispensing end of the tube 40. A plunger rod 28 has a dispensing end piston driving plate 29 which, upon longitudinal extension within the hollow bore 43 of tube 40, may engage and longitudinally drive the tube's internal piston 41. Driving of piston 40 ejects caulk 60 forwardly through nipple 42.

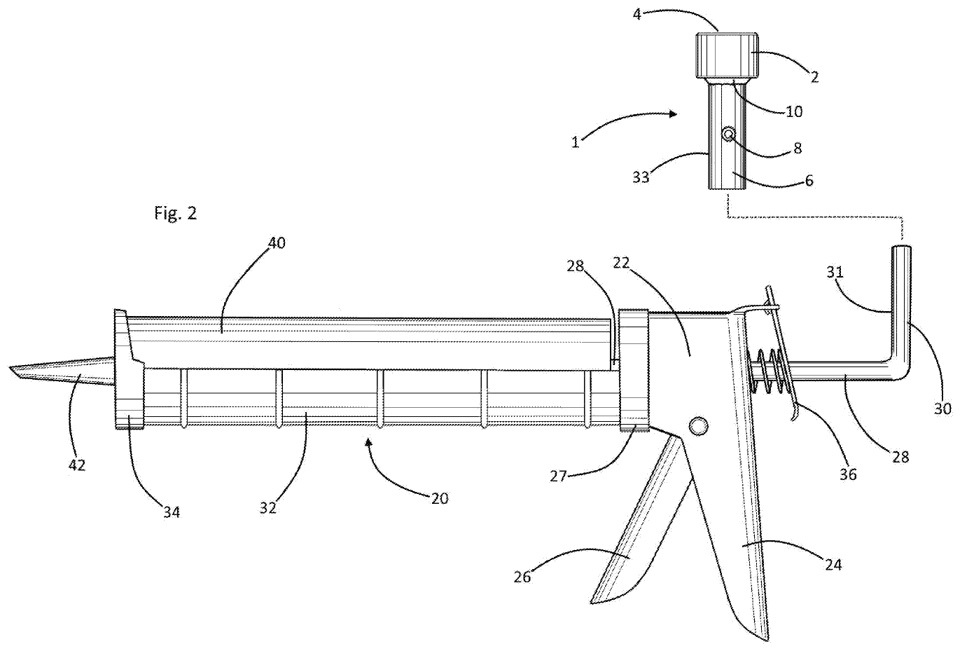

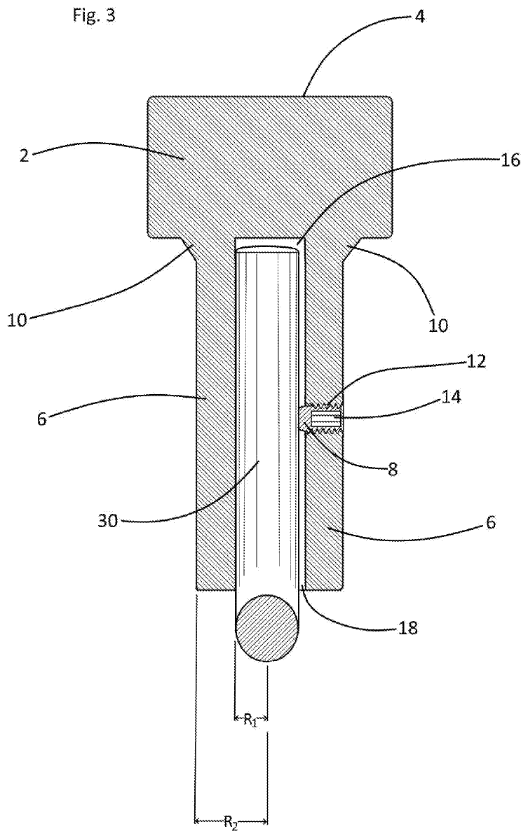

A plunger rod driving mechanism preferably including at least a first shaft binding slip plate (not depicted within views) within handle housing 22 may be actuated via finger pressure imposed reciprocating movements of a trigger portion 26 of the caulk gun's rear handle 24. Manual rearward squeezing of trigger 26 toward handle 24 actuates the at least first slip plate to progressively drive the plunger rod 28 longitudinally, driving plunger disk 29 against piston 41, and dispensing the caulk 60 out of nipple 42. While the caulk is under pressure from such trigger actuated driving action, and while the at least first slip plate is being retracted for a next successive longitudinal piston driving stroke, a second shaft binding slip plate 36 advantageously resists any oppositely longitudinal motion of the piston 41, the plate 29, and the plunger rod 28. Referring simultaneously to FIGS. 1-3, a hammerhead assembly 1 is preferably provided, such assembly including a hammerhead 2 having a strike face 4, and having a cylindrical mounting sleeve 6. A hollow bore 16 component of the hammerhead assembly 1 has a proximal opening 18 which is fitted for nesting receipt of a hook 30 formed at the handle end of the plunger rod 28, such hook 30 commonly being configured as an “L”. The hammerhead 2 may suitably be fixedly attached to a distal end of the sleeve 6 by a heat fusion weld 10. A helically threaded set screw 8 extends through a side wall threaded aperture 12 for secure impingement against a side wall of the hook 30, such set screw 8 having a hexagonal Allen wrench receiving socket 14.

In the preferred embodiment, the longitudinal aspect or face 31 of the hook 30 has a radius of curvature R₁, and the sleeve 6 has a substantially larger radius of curvature R₂. In a preferred embodiment, curvature R₂ is at least twice as great as the curvature R₁, such differential in curvatures ergonomically enhancing finger contact during use of the hook as a pull handle.

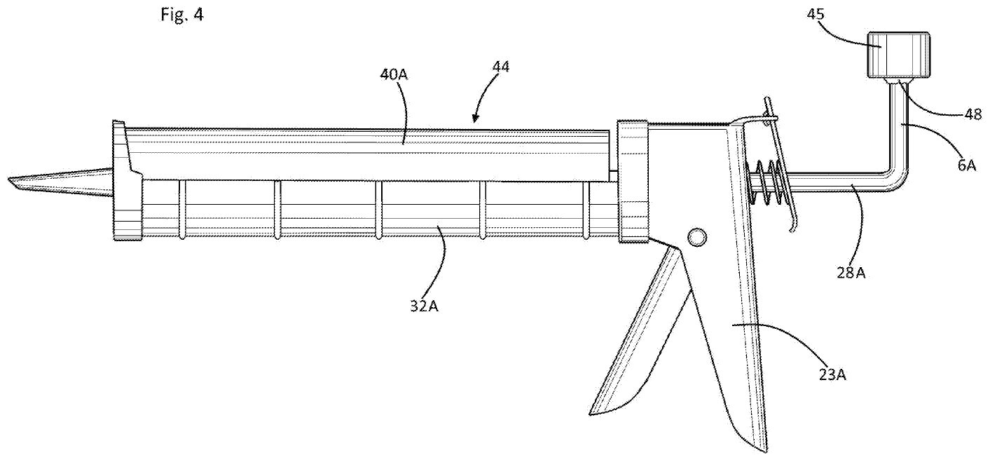

The sleeve 6 of Drawing FIGS. 1, 2, and 3, and the heat fusion weld 48 of FIG. 4 are intended as being representative of other means for mounting the hammerhead 2 (or 45 as the case may be), such as helically and threaded joints, pressure fitted joints, wholly formed joints, clamp joints, and adhesively bonded joints.

In use of the instant inventive caulking gun, and assuming an initial configuration as indicated in Drawing FIG. 1, an operator may grasp the receptacle 32 and the tube 40 with one hand while holding, for example, a ladder rung with the other hand. Thereafter, the operator may swing the caulking gun 20 in a manner of a hammer stroke, causing the strike face 4 of the hammerhead 2 to approach a raised nail head in need of resetting. Repeated striking of such strike face 4 against such nail head advantageously resets the nail without the requirement of awkwardly retrieving and utilizing a separate hammer tool.

Following utilization of the caulking gun 20 as a hammer, the operator may recommence use of the gun 20 for caulking. Upon emptying the tube 40, the operator may depress the lower end of retainer plate 36, and may utilize the fingers of his or her other hand to pull rearwardly upon sleeve 6. During such pulling action, the increased radius of curvature R₂ of sleeve 6 in relation to the lesser radius of curvature R₁ of the hook 30 advantageously provides ergonomic comfort which facilitates the rearward finger pull. Completion of such rearward pull advantageously retracts the driver plate 29 into the receptacle's rear shroud 27. Such sleeve assisted retraction allows the tube 40 to be withdrawn and disposed of, and allows a new caulk filled tube to be reinserted into receptacle 32.

Referring simultaneously to all figures, each structure appearing in FIG. 4 and having a suffix “A”, is configured substantially identically with similarly numbered structures appearing in FIGS. 1, 2, and 3. The alternative caulking gun 44 of FIG. 4 includes a hammerhead mounting means which directly welds hammerhead 45 to the distal end of hook 6A.

While the principles of the invention have been made clear in the above illustrative embodiment, those skilled in the art may make modifications to the structure, arrangement, portions and components of the invention without departing from those principles. Accordingly, it is intended that the description and drawings be interpreted as illustrative and not in the limiting sense, and that the invention be given a scope commensurate with the appended claims.

1. A caulking gun comprising:
(a) a caulk tube receptacle having a dispensing end and a handle end;
(b) a plunger rod having a dispensing end and a handle end, wherein the plunger rod's dispensing end extends toward the receptacle's dispensing end, and wherein the plunger rod's handle end extends away from the receptacle's handle end;
(c) a trigger actuator operatively supporting the plunger rod at the caulk tube receptacle's handle end;
(d) a hammerhead; and
(e) means for mounting the hammerhead, said means fixedly attaching the hammerhead to the plunger rod's handle end.

2. The caulking gun of claim 1 wherein the handle end of the plunger rod forms a hook.

3. The caulking gun of claim 2 wherein the means for mounting the hammerhead comprise a joint selected from the group consisting of pin and socket joints, welded joints, helically threaded joints, pressure fitted joints, adhesive joints, clamp joints, and wholly formed joints.

4. The caulking gun of claim 2 wherein the means for mounting the hammerhead comprise a sleeve having a distal end and having a hollow bore, the sleeve's distal end being fixedly attached to the hammerhead and the sleeve's hollow bore being fitted for nestingly receiving the hook.

5. The caulking gun of claim 4 further comprising a set screw, the set screw being helically threadedly mounted upon the sleeve, and the set screw being adapted for releasably holding the sleeve and the hammerhead upon the hook.

6. The caulking gun of claim 1 further comprising first and second pull handles, wherein the first pull handle comprises a hook formed at the handle end of the plunger rod, wherein the second pull handle comprises a sleeve having a distal end, wherein sleeve nestingly receives the hook, and wherein the hammerhead is fixedly attached to the sleeve's distal end.

7. The caulking gun of claim 6 wherein each handle among the first and second pull handles has a radius of curvature, and wherein the first handle's radius of curvature is substantially less than that of the second handle.

8. The caulking gun of claim 7 further comprising a set screw helically threadedly mounted upon the sleeve, the set screw being adapted for releasably holding the sleeve and the hammerhead upon the hook.
